(19) United States
(12) Patent Application Publication
(10) Pub. No.: US 2013/0335395 A1
(43) Pub. Date: Dec. 19, 2013

(54) ORGANIC LIGHT EMITTING DISPLAY AND METHOD OF DRIVING THE SAME

(71) Applicants: Zhi-Feng ZHAN, Yongin-City (KR); Eun-Joo CHO, Yongin-City (KR); Kun-Won LEE, Yongin-City (KR)

(72) Inventors: Zhi-Feng ZHAN, Yongin-City (KR); Eun-Joo CHO, Yongin-City (KR); Kun-Won LEE, Yongin-City (KR)

(21) Appl. No.: 13/668,801

(22) Filed: Nov. 5, 2012

(30) Foreign Application Priority Data
Jun. 15, 2012 (KR) 10-2012-0064330

(51) Int. Cl. G09G 3/32; G06F 3/038

(52) U.S. Cl. 345/212; 345/82

(57) ABSTRACT

An organic light emitting display includes pixels positioned at intersections of scan lines, emission control lines, control lines, and data lines, wherein gate voltages of driving transistors of the pixels are initialized by a first or second initialization power supply and an initialization power supply generating unit for supplying the first initialization power supply to pixels positioned in odd horizontal lines via a first power supply line and for supplying the second initialization power supply to pixels positioned in even horizontal lines via a second power supply line. The first initialization power supply and the second initialization power supply repeat a high voltage and a low voltage with different phases.

### CROSS-REFERENCE TO RELATED APPLICATION

This application claims priority under 35 U.S.C. §119 to and the benefit of Korean Patent Application No. 10-2012-0064330, filed on Jun. 15, 2012, in the Korean Intellectual Property Office, the entire content of which is incorporated herein by reference.

### BACKGROUND

1. Field

Embodiments relate to an organic light emitting display and a method of driving the same, and more particularly, to an organic light emitting display capable of displaying an image with uniform brightness and a method of driving the same.

2. Description of the Related Art

Recently, various flat panel displays (FPD) have been developed. The FPDs include liquid crystal displays (LCD), field emission displays (FED), plasma display panels (PDP), and organic light emitting displays. Among the FPDs, the organic light emitting displays display images using organic light emitting diodes (OLED) that generate light by re-combination of electrons and holes. The organic light emitting display has high response speed and low power consumption.

The organic light emitting display includes a plurality of pixels arranged at intersections of a plurality of data lines, scan lines, and power supply lines in a matrix. The pixels commonly include organic light emitting diodes (OLED) and driving transistors for controlling the amount of current that flows to the OLEDs. The pixels generate light with predetermined brightness while supplying current from the driving transistors to the OLEDs to correspond to data signals.

However, in the conventional pixel, when a white gray scale is realized after realizing a black gray scale as illustrated in FIG. 1, light with lower brightness than desired brightness may be generated over about two frame periods. In this case, an image with desired brightness is not displayed by the pixels to correspond to gray scales so that uniformity of brightness deteriorates and that picture quality of a moving picture deteriorates.

### SUMMARY

Embodiments are directed to providing an organic light emitting display, including pixels positioned at intersections of scan lines, emission control lines, control lines, and data lines and having gate voltages of driving transistors initialized by a first or second initialization power supply and an initialization power supply generating unit for supplying the first initialization power supply to pixels positioned in odd horizontal lines via a first power supply line and for supplying the second initialization power supply to pixels positioned in even horizontal lines via a second power supply line. The first initialization power supply and the second initialization power supply repeat a high voltage and a low voltage with different phases.

The phases of the first initialization power supply and the second initialization power supply are opposite to each other. The high voltage is set to apply an off bias voltage to the driving transistor and the low voltage is set to apply an on bias voltage to the driving transistor. The low voltage is set as a lower voltage than data signals supplied to the data lines.

The organic light emitting display further includes a data driver for supplying a plurality of data signals to output lines in a data period of a horizontal period, a scan driver for sequentially supplying scan signals to the scan lines in a scan period excluding the data period of the horizontal period and for sequentially supplying emission control signals to the emission control lines, a demultiplexer coupled to the output lines to supply a plurality of data signals to a plurality of data lines in the data period, and data capacitors formed in the data lines to store the data signals.

An emission control signal supplied to an ith (i is a natural number) emission control line overlaps scan signals supplied to an (i−1)th scan line and an ith scan line. A control signal supplied to an ith control line overlaps an emission control signal supplied to the ith emission control line and has an opposite polarity to the polarity of the emission control signal supplied to the ith emission control line. A first initialization power supply repeats a high voltage and a low voltage in a period where emission control signals are supplied to emission control lines positioned in even horizontal lines. A second initialization power supply repeats a high voltage and a low voltage in a period where emission control signals are supplied to emission control lines positioned in odd horizontal lines.

Each of the pixels positioned in the ith (i is a natural number) horizontal line includes an organic light emitting diode (OLED) having a cathode electrode coupled to a second power supply, a first transistor coupled between a data line and a first node and turned on when a scan signal is supplied to an ith scan line, the driving transistor coupled between the first node and the OLED and having a gate electrode coupled to a second node, a third transistor coupled between the second node and the first power supply line or the second power supply line and turned on when a control signal is supplied to an (i−1)th control line, a fourth transistor coupled between a second electrode of the second transistor and the second node and turned on when a scan signal is supplied to the ith scan line, and a storage capacitor coupled between the second node and a first power supply.

The organic light emitting display further includes a fifth transistor coupled between the second electrode of the second transistor and the OLED and turned off when an emission control signal is supplied to the ith emission control line, a sixth transistor coupled between the first node and the first power supply and turned off when an emission control signal is supplied to the ith emission control line, and a boosting capacitor coupled between the ith scan line and the second node.

There is provided a method of driving an organic light emitting display, including supplying a first initialization power supply to first pixels positioned in odd horizontal lines to initialize gate electrodes of driving transistors included in the first pixels and supplying a second initialization power supply to second pixels positioned in even horizontal lines to initialize gate electrodes of driving transistors included in the second pixels. The first initialization power supply and the second initialization power supply repeat a high voltage and a low voltage with different phases.

The first initialization power supply and the second initialization power supply have opposite phases. The high voltage is set to apply an off bias voltage to the driving transistor and the low voltage is set to apply an on bias voltage to the driving transistor. The driving transistors continuously receive the high voltage and the low voltage before charging voltages corresponding to data signals.

In the organic light emitting display according to the present invention and the method of driving the same, the off bias voltage and the on bias voltage are continuously supplied to the driving transistors before the data signals are applied to initialize the characteristics of the driving transistors. In this case, the driving transistors may display an image with desired brightness regardless of the data signals of a previous period.

### BRIEF DESCRIPTION OF THE DRAWINGS

FIG. 1 is a view illustrating brightness displayed when a white gray scale is realized after realizing a black gray scale;

FIG. 2 is a view illustrating an organic light emitting display according to an embodiment of the present invention;

FIG. 3 is a view illustrating an embodiment of an internal circuit of the demultiplexer of FIG. 2;

FIG. 4 is a view illustrating driving waveforms according to the embodiment of the present invention; and

FIG. 5 is a circuit diagram illustrating a pixel according to the embodiment of the present invention.

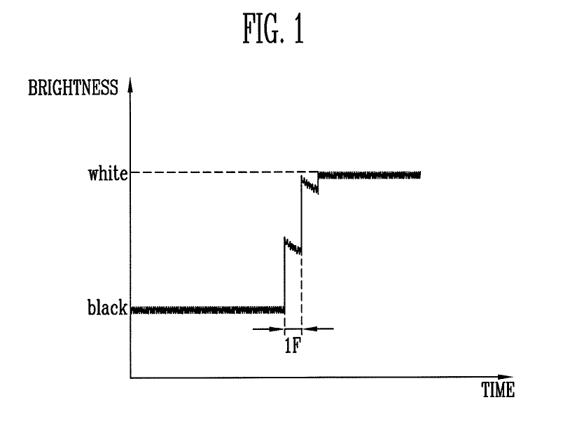

### DETAILED DESCRIPTION

Hereinafter, certain exemplary embodiments will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

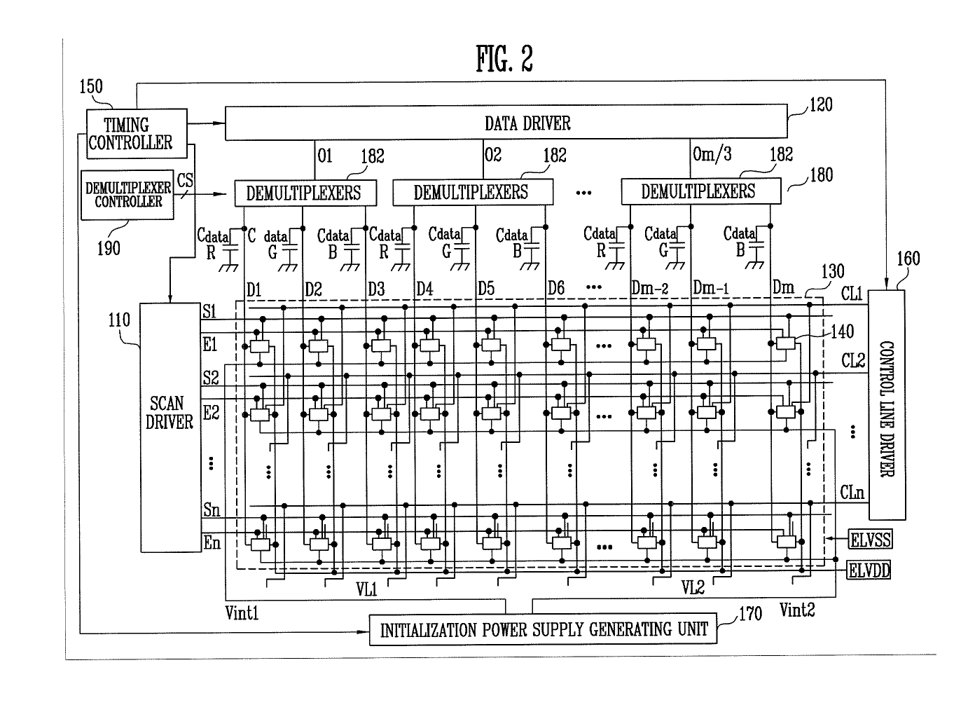

FIG. 2 is a view illustrating an organic light emitting display according to an embodiment. In FIG. 2, a demultiplexer 182 is coupled to three data lines. However, embodiments are not limited thereto. For example, the demultiplexer 182 may be coupled to at least two data lines.

Referring to FIG. 2, the organic light emitting display according to the present embodiment includes a pixel unit 130 including pixels 140 positioned at intersections of scan lines S1 to Sn, emission control lines E1 to En, control lines CL1 to CLn, and data lines D1 to Dm, a scan driver 110 for driving the scan lines S1 to Sn and the emission control lines E1 to En, a control line driver 160 for driving the control lines CL1 to CLn, and a data driver 120 for driving the data lines D1 to Dm.

In addition, the organic light emitting display according to the present embodiment includes a first power supply line VL1 coupled to the pixels 140 positioned in odd horizontal lines, a second power supply line VL2 coupled to the pixels 140 positioned in even horizontal lines, an initialization power supply generating unit 170 for supplying a first initialization power supply Vint1 to the first power supply line VL1 and for supplying a second initialization power supply Vint2 to the second power supply line VL2, and a timing controller 150 for controlling the scan driver 110, the data driver 120, the control line driver 160, and the initialization power supply generating unit 170.

The organic light emitting display according to the present embodiment includes a demultiplexer unit 180, a demultiplexer controller 190, and data capacitors Cdata. The scan driver 110 sequentially supplies scan signals to the scan lines S1 to Sn and sequentially supplies emission control signals to the emission control lines E1 to En. The scan driver 110 supplies scan signals only in a partial period of a one horizontal period 1H as illustrated in FIG. 4.

Describing the above in detail, according to the present embodiment, the one horizontal period 1H is divided into a scan period and a data period. The scan driver 110 supplies a scan signal to the scan line S in the scan period of the one horizontal period 1H. The scan driver 110 does not supply the scan signal in the data period of the one horizontal period 1H. On the other hand, the emission control signals generated by the scan driver 110 are supplied in at least two horizontal periods. For example, the emission control signal supplied to the ith emission control line Ei overlaps the scan signals supplied to the (i−1)th scan line Si−1 and the ith scan line Si.

The control line driver 160 sequentially supplies control signals to the control lines CL1 to CLn. Here, the control signal supplied to the ith control line CLi overlaps the emission control signal supplied to the ith emission control line Ei and has an opposite polarity to the polarity of the emission control signal supplied to the ith emission control line Ei. For example, the emission control signals are set as high voltages so that the transistors included in the pixels 140 may be turned off and the control signals are set as low voltages so that the transistors included in the pixels 140 may be turned on.

Since the control signals have an opposite polarity to the polarity of the emission control signals and are supplied to overlap the emission control signals in units of horizontal lines, the control signals may be generated by inverting the emission control signals. For example, inverters are added to the emission control lines E1 to En so that the control signals may be supplied to the control lines CL1 to CLn. In this case, the control line driver 160 may be omitted, reducing manufacturing costs.

The data driver 120 generates data signals and supplies the generated data signals to output lines O1 to Om/3. Here, the data driver 120 sequentially supplies three data signals to the output lines O1 to Om/3 in the one horizontal period 1H.

Describing the above in detail, the data driver 120 sequentially supplies three data signals R, G, and B to be actually supplied to a pixel in the data period of the one horizontal period 1H. Here, since the data signals R, G, and B are supplied only in the data period, the supply time of the data signals R, G, and B does not overlap the supply time of the scan signals. The data driver 120 supplies dummy data DD that does not contribute to brightness in the scan period of the one horizontal period 1H. Here, since the dummy data DD does not contribute to brightness, the dummy data DD may not be supplied.

The demultiplexer unit 180 includes m/3 demultiplexers 182. That is, the demultiplexer unit 180 includes the same number of demultiplexers 182 as the output lines O1 to Om/3 and each of the demultiplexers 182 is coupled to one of the output lines O1 to Om/3. The demultiplexers 182 are coupled to the three data lines D, respectively. The demultiplexers 182 supply the three data signals supplied to the output lines O to the three data lines D in the data period.

When the data signals supplied to one output line O are supplied to the three data lines D, the number of output lines O included in the data driver 120 is rapidly reduced. For example, when the demultiplexers 182 are coupled to the three data lines D, the number of output lines O is reduced to ⅓ so that the number of data driving circuits included in the data driver 120 is reduced. That is, according to the present embodiment, the data signals supplied to one output line O are supplied to the plurality of data lines D using the demultiplexers 182, reducing manufacturing costs.

The demultiplexer controller 190 supplies three signals CS1, CS2, and CS3 to the demultiplexers 182 in the data period of the one horizontal period 1H so that the three data signals supplied to the output line O may be supplied to the three data lines D. Here, the demultiplexer controller 190 sequentially supplies the three signals CS1, CS2, and CS3 supplied in the data period so as not to overlap as illustrated in FIG. 4.

The data capacitors Cdata are provided in the data lines D, respectively. The data capacitors Cdata temporarily store the data signals supplied to the data lines D and supply the stored data signals to the pixels 140. Here, the data capacitors Cdata may be parasitic capacitors equivalently formed in the data lines D. Since the parasitic capacitors equivalently formed in the data lines D have larger capacity than the storage capacitors formed in the pixels 140, the data signals may be stably stored.

The initialization power supply generating unit 170 supplies the first initialization power supply Vint1 to the first power supply line VL1 and supplies the second initialization power supply Vint2 to the second power supply line VL2. The first initialization power supply Vint1 and the second initialization power supply Vint2 are supplied to repeat a high voltage and a low voltage in a period where the emission control signals are supplied. Here, the values of the high voltages of the initialization power supplies Vint1 and Vint2 are set so that an off bias voltage is applied to the driving transistors included in the pixels 140 and the values of the low voltages of the initialization power supplies Vint1 and Vint2 are set so that an on bias voltage is applied to the driving transistors included in the pixels 140.

The first initialization power supply Vint1 is set as a high voltage in a partial period of a period in which emission control signals are supplied to even emission control lines En and is set as a low voltage in the remaining period. The second initialization power supply Vint2 is set as a high voltage in a partial period of a period in which emission control signals are supplied to odd emission control lines En−1 and is set as a low voltage in the remaining period. In other words, the first initialization power supply Vint1 and the second initialization power supply Vint2 may have reversed or opposite phases.

In FIG. 4, the high voltages of the first initialization power supply Vint1 and the second initialization power supply Vint2 are supplied in a longer period than the low voltages of the first initialization power supply Vint1 and the second initialization power supply Vint2. However, embodiments are not limited to the above. In particular, the supply periods of the high voltage and the low voltage may be variously set in consideration of a panel and resolution so that the characteristics of the driving transistors may be initialized.

The timing controller 150 controls the scan driver 110, the data driver 120, the control line driver 160, and the initialization power supply generating unit 170.

The pixel unit 130 includes the pixels 140 positioned at the intersections of the scan lines S1 to Sn and the data lines D1 to Dm. Here, the pixel 140 positioned in an ith (i is a natural number) is coupled to an ith scan line Si, an ith emission control line Ei, and an (i−1)th control line CLi−1. The pixels 140 receive a first power supply ELVDD and a second power supply ELVSS set as a lower voltage than the first power supply ELVDD. The pixels 140 that receive the first power supply ELVDD and the second power supply ELVSS generate light with predetermined brightness while controlling the mount of current that flows from the first power supply ELVDD to the second power supply ELVSS via OLEDs to correspond to the data signals.

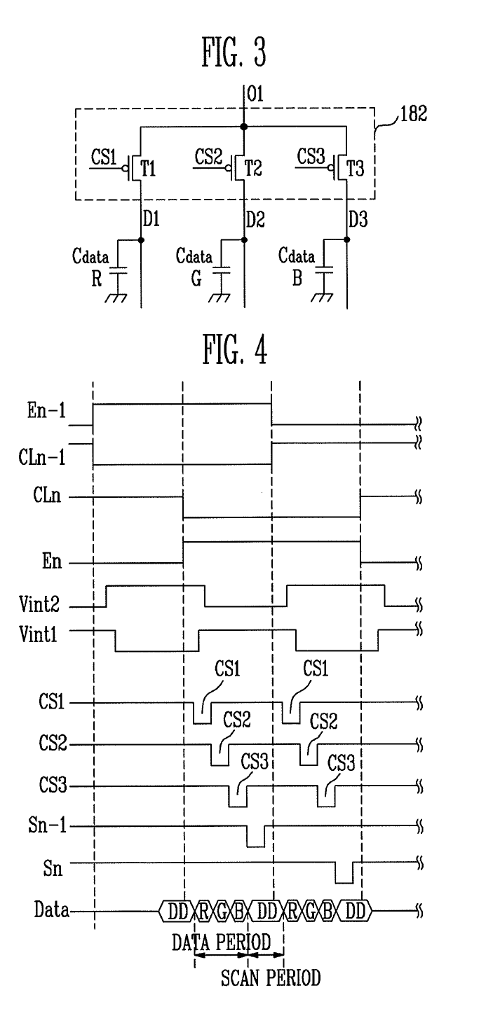

FIG. 3 is a view illustrating an embodiment of an internal circuit of the demultiplexer of FIG. 2. In FIG. 3, the demultiplexer 182 coupled to the first output line O1 is illustrated for convenience sake. Referring to FIG. 3, the demultiplexers 182 include a first switching element T1, a second switching element T2, and a third switching element T3.

The first switching element T1 is coupled between the first output line O1 and the first data line D1. The first switching element T1 is turned on when the first signal CS1 is supplied from the demultiplexer controller 190 to supply the data signal supplied to the first output line O1 to the first data line D1. The data signal supplied to the first data line D1 when the first signal CS1 is supplied is temporarily stored in the first data capacitor CdataR.

The second switching element T2 is coupled between the first output line O1 and the second data line D2. The second switching element T2 is turned on when the second signal CS2 is supplied from the demultiplexer controller 190 to supply the data signal supplied to the first output line O1 to the second data line D2. The data signal supplied to the second data line D2 when the second signal CS2 is supplied is temporarily stored in the second data capacitor CdataG.

The third switching element T3 is coupled between the first output line O1 and the third data line D3. The third switching element T3 is turned on when the third signal CS3 is supplied from the demultiplexer controller 190 to supply the data signal supplied to the first output line O1 to the third data line D3. The data signal supplied to the third data line D3 when the third signal CS3 is supplied is temporarily stored in the third data capacitor CdataB.

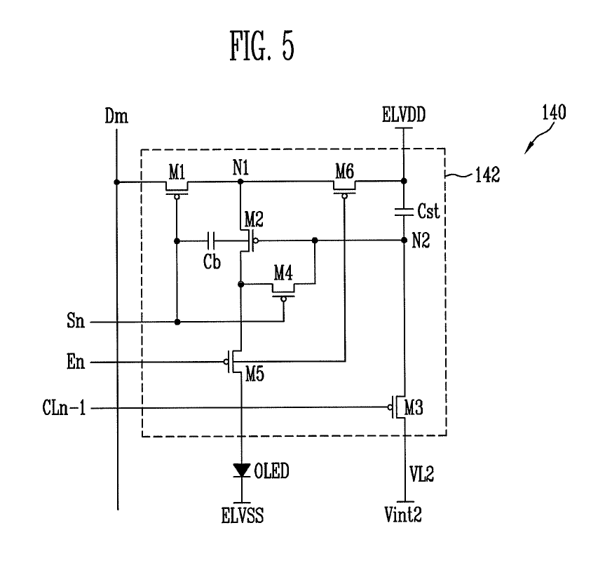

FIG. 5 is a circuit diagram illustrating a pixel according to the embodiment of the present invention. In FIG. 5, for convenience sake, the pixel coupled to the nth scan line Sn and the mth data line Dm is illustrated. Referring to FIG. 5, the pixel 140 according to the present embodiment includes an OLED and a pixel circuit 142 for controlling the amount of current supplied to the OLED.

The anode electrode of the OLED is coupled to the pixel circuit 142 and the cathode electrode of the OLED is coupled to the second power supply ELVSS. The OLED generates light with predetermined brightness to correspond to the current supplied from the pixel circuit 142.

The pixel circuit 142 charges a voltage corresponding to a data signal and controls the amount of current supplied to the OLED to correspond to the charged voltage. The pixel circuit 142 applies an initialization power supply to a driving transistor M2 to correspond to a control signal to uniformly maintain the characteristic of the driving transistor M2. Therefore, the pixel circuit 142 includes first to sixth transistors M1 to M6, a storage capacitor Cst, and a boosting capacitor Cb.

The first electrode of a first transistor M1 is coupled to the data line Dm and the second electrode of the first transistor M1 is coupled to a first node N1. The gate electrode of the first transistor M1 is coupled to the scan line Sn. The first transistor M1 is turned on when a scan signal is supplied to the scan line Sn to electrically couple the data line Dm to the first node N1.

The first electrode of a second transistor M2 is coupled to the first node N1 and the second electrode of the second transistor M2 is coupled to the first electrode of a fifth transistor M5. The gate electrode of the second transistor M2 is coupled to a second node N2. The second transistor M2 controls the amount of current supplied from the first power supply ELVDD to the second power supply ELVSS via the OLED to correspond to a voltage applied to the second node N2.

The first electrode of a third transistor M3 is coupled to the second node N2 and the second electrode of the third transistor M3 is coupled to the second power supply line VL2. The gate electrode of the third transistor M3 is coupled to the (n−1)th control line CLn−1. The third transistor M3 is turned on when a control signal is supplied to the (n−1)th control line CLn−1 to supply the voltage of the second initialization power supply Vint2 to the gate electrode of the second transistor M2. Therefore, in a period where the control signal is supplied to the (n−1)th control line CLn−1, the off bias voltage and the on bias voltage are continuously applied to the gate electrode of the second transistor M2.

The first electrode of a fourth transistor M4 is coupled to the second electrode of the second transistor M2 and the second electrode of the fourth transistor M4 is coupled to the second node N2. The gate electrode of the fourth transistor M4 is coupled to the scan line Sn. The fourth transistor M4 couples the second transistor M2 in a form of a diode when the scan signal is supplied to the scan line Sn.

The first electrode of the fifth transistor M5 is coupled to the second electrode of the second transistor M2 and the second electrode of the fifth transistor M5 is coupled to the anode electrode of the OLED. The gate electrode of the fifth transistor M5 is coupled to the emission control line En. The fifth transistor M5 is turned off when the emission control signal is supplied to the emission control line En and is otherwise turned on.

The first electrode of the sixth transistor M6 is coupled to the first power source ELVDD and the second electrode of the sixth transistor M6 is coupled to the first node N1. The gate electrode of the sixth transistor M6 is coupled to the emission control line En. The sixth transistor M6 is turned off when the emission control signal is supplied to the emission control line En and is turned on in the other cases.

The storage capacitor Cst is coupled between the second node N2 and the first power supply ELVDD. The storage capacitor Cst charges a predetermined voltage to correspond to a data signal.

A boosting capacitor Cb is coupled between the scan line Sn and the second node N2. The boosting capacitor Cb increases the voltage of the second node N2 to correspond to the scan signal.

Operation processes are described in detail with reference to FIGS. 4 and 5. First, a control signal is supplied to the (n−1)th control line CLn−1. When the control signal is supplied to the (n−1)th control line CLn−1, the third transistor M3 is turned on. When the third transistor M3 is turned on, the second power source line VL2 and the second node N2 are electrically coupled to each other so that the second initialization power supply Vint2 is supplied to the second node N2. The second initialization power supply Vint2 is sequentially set as a high voltage and a low voltage in a period where the control signal is supplied to the (n−1)th control line CLn−1.

When the second initialization power supply Vint2 is set as the high voltage, an off bias voltage is applied to the second transistor M2. When the second initialization power supply Vint2 is set as the low voltage, the on bias voltage is applied to the second transistor M2. When the off bias voltage and the on bias voltage are sequentially supplied to the gate electrode of the second transistor M2, the threshold voltage of the second transistor M2 is initialized to a uniform state, for example, an initial state.

That is, according to the present embodiment, the off bias voltage and the on bias voltage are sequentially applied to the second transistor M2 before a data signal is applied to the gate electrode of the second transistor M2 to initialize the characteristic of the second transistor M2. In this case, the second transistor M2 may display an image with desired brightness regardless of the data signal of a previous period. Experiments demonstrate that characteristics of the second transistor M2 are stably initialized when the off bias voltage and the on bias voltage are sequentially applied as compared with when only the off bias voltage or the on bias voltage is applied.

The data signals supplied to the data lines D1 to Dm in the latter half 1H of a period of 2H in which the control signal is supplied to the (n−1)th control line CLn−1 are supplied to the pixels positioned in an (n−1)th horizontal line to correspond to the scan signal supplied to the (n−1)th scan line Sn−1. That is, in the period where the control signal is supplied to the (n−1)th control line CLn−1, data signals are not supplied to the pixels positioned in an nth horizontal line so that the characteristic of the second transistor M2 is stably initialized.

The emission control signal is supplied to the nth emission control line En to overlap the latter half 1H of the period of 2H to which the control signal is supplied to the (n−1)th control line CLn−1. When the emission control signal is supplied to the nth emission control line En, the fifth transistor M5 and the sixth transistor M6 are turned off. Then, supply of the control signal to the (n−1)th control line CLn−1 is stopped.

After the supply of the control signal to the (n−1)th control line CLn−1 is stopped, the first signal CS1 to the third signal CS3 are sequentially supplied. When the first signal CS1 to the third signal CS3 are sequentially supplied, voltages corresponding to the data signals are charged in the data capacitors Cdata of the data lines D1 to Dm.

Then, the scan signal is supplied to the nth scan line Sn so that the first transistor M1 and the fourth transistor M4 are turned on. When the fourth transistor M4 is turned on, the second transistor M2 is coupled in the form of a diode. When the first transistor M1 is turned on, the data signals charged in the data capacitors Cdata are supplied to the first node N1. At this time, since the second node N2 is initialized to the low voltage of the second initialization power supply Vint2, the second transistor M2 is turned on. Therefore, the low voltages of the initialization power supplies Vint1 and Vint2 are set as voltage lower than the data signals.

When the second transistor M2 is turned on, the data signal applied to the first node N1 is supplied to the second node N2 via the diode coupled second transistor M2. At this time, the storage capacitor Cst charges a voltage corresponding to the voltage applied to the second node N2.

Then, supply of the emission control signal to the nth emission control line En is stopped. When the supply of the emission control signal to the nth emission control line En is stopped, the fifth transistor M5 and the sixth transistor M6 are turned on. At this time, the second transistor M2 supplies a small amount of current to the OLED by the first power supply ELVDD to correspond to the voltage stored in the storage capacitor Cst.

Additionally, the boosting capacitor Cb increases the voltage of the second node N2 when supply of the scan signal to the scan line Sn is stopped. In this case, the lost voltages of the data signals may be compensated for by the data capacitors Cdata.

The pixels 140 according to the present embodiment generate light with predetermined brightness by the above-described processes. The pixels positioned in the odd horizontal lines are initialized by the first initialization power supply Vint1 and the pixels positioned in the even horizontal lines are initialized by the second initialization power supply Vint2.

Embodiments may be used with pixels having structures different from that illustrated in FIG. 5. For example, embodiments may be applied to various types of pixels in which driving transistors are coupled in the form of a diode to receive the voltages of the initialization power supplies Vint so that an image with uniform brightness is displayed.

By way of summation and review, by sequentially applying an off bias voltage and an on bias voltage in accordance with embodiments, an image having a desired brightness regardless of the characteristics of the driving transistor may be realized. Thus, shifting of the threshold voltage of the driving transistor to correspond to a voltage applied to the driving transistor in a previous frame period may be reduced or eliminated so that light with desired brightness may be generated in a current frame.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display, comprising:
pixels positioned at intersections of scan lines, emission control lines, control lines, and data lines, wherein gate voltages of driving transistors of the pixels are initialized by a first or second initialization power supply; and
an initialization power supply generating unit for supplying the first initialization power supply to pixels positioned in odd horizontal lines via a first power supply line and for supplying the second initialization power supply to pixels positioned in even horizontal lines via a second power supply line,
wherein the first initialization power supply and the second initialization power supply repeat a high voltage and a low voltage at different phases.

2. The organic light emitting display as claimed in claim 1, wherein the phases of the first initialization power supply and the second initialization power supply are opposite each other.

3. The organic light emitting display as claimed in claim 1,
wherein the high voltage is set to apply an off bias voltage to the driving transistor, and
wherein the low voltage is set to apply an on bias voltage to the driving transistor.

4. The organic light emitting display as claimed in claim 3, wherein the low voltage is set as a lower voltage than data signals supplied to the data lines.

5. The organic light emitting display as claimed in claim 1, further comprising:
a data driver for supplying a plurality of data signals to output lines in a data period of a horizontal period;
a scan driver for sequentially supplying scan signals to the scan lines in a scan period excluding the data period of the horizontal period and for sequentially supplying emission control signals to the emission control lines;
a demultiplexer coupled to the output lines to supply a plurality of data signals to a plurality of data lines in the data period; and
data capacitors in the data lines to store the data signals.

6. The organic light emitting display as claimed in claim 5, wherein an emission control signal supplied to an ith (i is a natural number) emission control line overlaps scan signals supplied to an (i−1)th scan line and an ith scan line.

7. The organic light emitting display as claimed in claim 6, wherein a control signal supplied to an ith control line overlaps the emission control signal supplied to the ith emission control line and has an opposite polarity to the polarity of the emission control signal supplied to the ith emission control line.

8. The organic light emitting display as claimed in claim 5,
wherein the first initialization power supply repeats a high voltage and a low voltage in a period where emission control signals are supplied to emission control lines in even horizontal lines, and
wherein the second initialization power supply repeats a high voltage and a low voltage in a period where emission control signals are supplied to emission control lines in odd horizontal lines.

9. The organic light emitting display as claimed in claim 5, wherein each of the pixels positioned in the ith (i is a natural number) horizontal line comprises:
an organic light emitting diode (OLED) having a cathode electrode coupled to a second power supply;
a first transistor coupled between a data line and a first node, the first transistor being turned on when a scan signal is supplied to an ith scan line;
the driving transistor coupled between the first node and the OLED, the driving transistor having a gate electrode coupled to a second node;
a third transistor coupled between the second node and the first power supply line or the second power supply line, the third transistor being turned on when a control signal is supplied to an (i−1)th control line;
a fourth transistor coupled between a second electrode of the second transistor and the second node, the fourth transistor being turned on when a scan signal is supplied to the ith scan line; and
a storage capacitor coupled between the second node and a first power supply.

10. The organic light emitting display as claimed in claim 9, further comprising:
a fifth transistor coupled between the second electrode of the second transistor and the OLED, the fifth transistor being turned off when an emission control signal is supplied to the ith emission control line;
a sixth transistor coupled between the first node and the first power supply, the sixth transistor and turned off when an emission control signal is supplied to the ith emission control line; and
a boosting capacitor coupled between the ith scan line and the second node.

11. A method of driving an organic light emitting display, the method comprising:
supplying a first initialization power supply to first pixels positioned in odd horizontal lines to initialize gate electrodes of driving transistors included in the first pixels; and
supplying a second initialization power supply to second pixels positioned in even horizontal lines to initialize gate electrodes of driving transistors included in the second pixels,
wherein the first initialization power supply and the second initialization power supply repeat a high voltage and a low voltage at different phases.

12. The method as claimed in claim 11, wherein the first initialization power supply and the second initialization power supply have opposite phases.

13. The method as claimed in claim 11,
wherein the high voltage is set to apply an off bias voltage to the driving transistor, and
wherein the low voltage is set to apply an on bias voltage to the driving transistor.

14. The method as claimed in claim 11, wherein the driving transistors continuously receive the high voltage and the low voltage before charging voltages corresponding to data signals.
